(19) United States
(12) Patent Application Publication
(10) Pub. No.: US 2008/0116713 A1
(43) Pub. Date: May 22, 2008

(54) Door frame

(76) Inventors: Won Seok Jun, Suwon-city (KR); Sungsik Kong, Seoul (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/642,448

(22) Filed: Dec. 20, 2006

(30) Foreign Application Priority Data
Nov. 17, 2006 (KR) 10-2006-0114113

(51) Int. Cl. B60J 5/00; B60J 1/00

(52) U.S. Cl. 296/146.2; 296/201

(57) ABSTRACT

A door molding portion, configured to be attached to a door glass mounting portion of a vehicle door, includes a substantially rectangular member with a first and a second end, and a curved member with a first and a second end, the first end of the curved member being connected to the first end of the rectangular member, wherein the curved member becomes gradually wider from the first end toward the second end. The curved member may include a mounting plate, a molding portion molded on the mounting plate, a protrusion protruding downward at a center of the mounting plate, and a bracket attached to the protrusion.

### CROSS-REFERENCE TO RELATED APPLICATION

This application claims priority to and the benefit of Korean Patent Application No. 10-2006-01141 13 filed in the Korean Intellectual Property Office on Nov. 17, 2006, the entire contents of which are incorporated herein by reference.

### BACKGROUND OF THE INVENTION

(a) Field of the Invention

The present invention relates to a door frame of vehicle, and more particularly, to a door molding portion of a door frame.

(b) Description of the Related Art

Generally, a vehicle door includes a door frame, a weatherstrip, and a door glass run that maintains air-tightness and covers the external edge of the door glass. In addition, door moldings having various colors and decorative shapes are provided. Such a door molding is inserted into the inner periphery to provide an air-tight seal at the edge of the door glass, and is made by a roll forming method so that it has a uniform width.

However, a door molding made by roll forming may not provide an air-tight seal to the door glass, particularly at a curved portion of a glass of a rear door. The door molding must also be curved; however, a roll formed curved portion may not provide an air-tight seal.

Accordingly, in order to solve such a problem, a dual injection method has been used in which a pattern portion is formed of stainless steel using an SUS pressing process and a resin is injected along the pattern portion. However, because at least a 3.0 mm thickness of resin is injection-molded, such a method may not be utilized if sufficient door glass mounting space is not provided. In addition, the door molding formed in such a method is heavy.

The above information disclosed in this Background section is only for enhancement of understanding of the background of the invention and therefore it may contain information that does not form the prior art that is already known in this country to a person of ordinary skill in the art.

### SUMMARY OF THE INVENTION

An exemplary embodiment of the present invention provides a door frame of a vehicle including a door molding portion for decorating a door glass mounting portion, wherein the door molding portion includes a rectangular member having a constant width and a curved member having a width different from that of the rectangular member and connected to one end portion of the rectangular member.

The curved member may have a curved shape that becomes gradually wider from the one end portion of the rectangular member in a downward direction.

The rectangular member may be attached on the door glass mounting portion using an adhesive tape, and may have a flange portion along a periphery thereof that is inserted into the door glass mounting portion.

The rectangular member may be a molding portion made by a roll forming method and may have a thickness of about 1 mm.

The curved member may include a mounting plate, a molding portion molded on the mounting plate, a protrusion protruding downward at the center portion of the mounting plate, and a bracket fastened to the protrusion. The molding portion of the curved member may have a thickness equal to that of the rectangular member. The molding portion may have a thickness of about 1 mm.

The molding portion may be made by a pressing process and have a flange portion at a periphery thereof such that it is attached to the mounting plate. The mounting plate may be injection-formed with a plastic material along with the protrusion and have a recess portion at the periphery thereof for fixing the flange portion of the molding portion. The mounting plate may have a protrusion for fixing the molding portion to the door frame and disposed with a predetermined space at the center portion thereof, and the protrusion may be a clip and be fixed to a bracket disposed at the glass run mounting portion.

The mounting plate may include a inlet portion, and the inlet portion may be attached to the glass run mounting portion by an adhesive tape, and may form a space at a lower portion of the mounting plate. The mounting plate may have an assembling guide pin for attaching the molding portion to the glass run mounting portion.

### BRIEF DESCRIPTION OF THE DRAWINGS

FIG. 1 is a perspective view of a door using a door frame according to an exemplary embodiment of the present invention.

FIG. 2 is a perspective view of part of a back surface of a door frame according to an exemplary embodiment of the present invention.

FIG. 3 is a cross-sectional view taken along line A-A of FIG. 2.

FIG. 4 is a cross-sectional view taken along line B-B of FIG. 2.

FIG. 5 is a cross-sectional view taken along line C-C of FIG. 2.

### DETAILED DESCRIPTION OF THE PREFERRED EMBODIMENTS

A door frame according to an exemplary embodiment of the present invention will be described in detail with reference to the drawings.

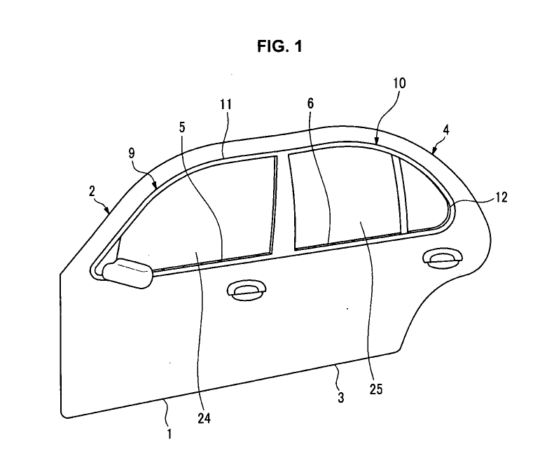

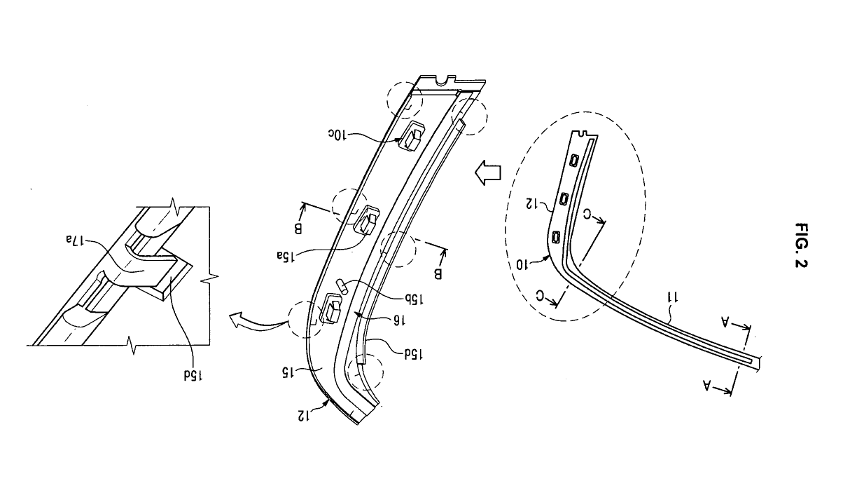

As shown in FIG. 1 and FIG. 2, a front door 1 has a front door frame 2 and a rear door 3 has a rear door frame 4.

The door frames 2 and 4 each have an outer frame and an inner frame, and the outer frame and inner frame have a glass run mounting groove attached with glass run channels 5 and 6 at the inner periphery. Door moldings 9 and 10 are inserted and attached into respective ones of the glass run mounting grooves.

According to an exemplary embodiment of the present invention, the door molding portions 9 and 10 horizontally extend from a center portion of the front and rear doors 1 and 4 to both sides thereof, and are then curved downward at the end portions of the front and rear doors 1 and 4. Referring to FIG. 2, the door molding portions 9 and 10 gradually become wider along the downward part thereof.

The door moldings 9 and 10 include a rectangular member 11 having a constant width and horizontally extending from a center portion of the front and rear doors 1 and 4 to both sides thereof, and a curved member curved in a downward direction at the rear portion of the rectangular member 11 of the door frame 2 and 4, in which the width gradually increases toward the bottom.

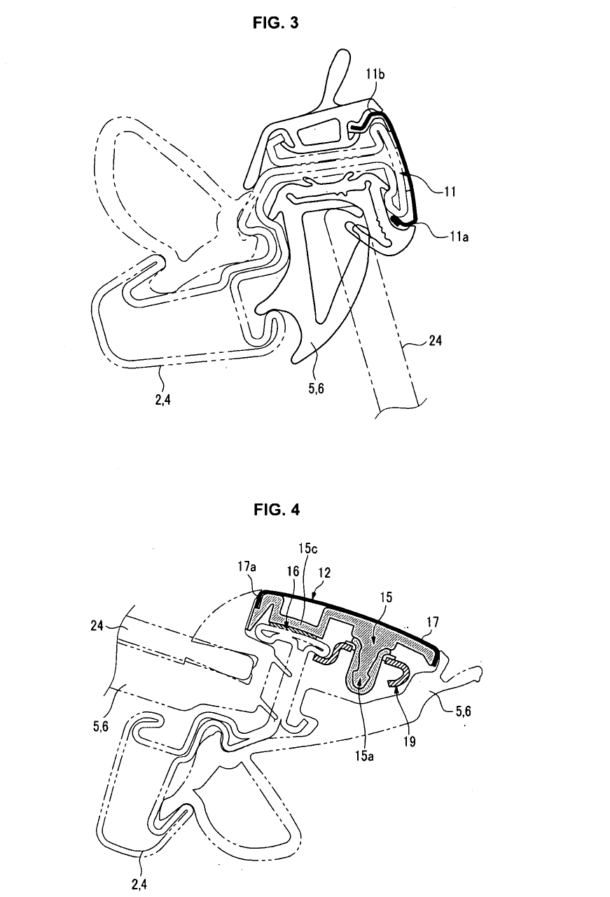

As shown in FIG. 3, the rectangular member 11 corresponding to a front portion of the door molding portion may be made of the same material as the glass run channels 5 and 6.

According to an exemplary embodiment of the present invention, the rectangular member 11 is made of a thermal plastic material and has a constant width. In addition, the rectangular member 11 has a flange portion 11a fitted into the glass run mounting groove at the periphery thereof. The rectangular member 11 is attached on the side opposite to the glass run mounting portion of the door frame, for example at the glass run channels 5 and 6, using, for example, a double-sided tape 16.

The rectangular member 11 is preferably flexible such that it covers the glass run channels 5 and 6 and it air-tightly seals the same. In addition, it preferably has a thickness of about 1 mm.

The curved member 12 may have a decorative pattern at an exposed surface. According to the illustrated embodiment, for example, the curved member 12 becomes wider toward the rear portion of the door frame 2 and 4, so that it may air-tightly seal the glass run.

As shown in FIG. 4, the curved member 12 includes a mounting plate 15 and a molding portion 17 molded on the mounting plate 15.

The molding portion 17 is made by a pressing process in a shape corresponding to the shape of the mounting plate 15, and the molding portion 17 is further provided with a flange portion 17a at the periphery thereof such that it is wrapped in the mounting plate 15.

The mounting plate 15 includes a plurality of protrusions 15a protruding in a downward direction at the center portion, a plurality of assembling guide pins 15b disposed at a predetermined interval among the protrusions 15a and for guiding the assembling of the molding portion 17 with the glass run mounting portion, a plurality of inlet portions 15c for forming a predetermined space, and a recess portion 15d formed at the periphery of the mounting plate 15, into which the flange portion 17a of the molding portion 17 is inserted, and accordingly, with which the mobility of the flange portion 17a is limited. These parts may all be injection-molded with a thermal plastic material. Several recess portions 15d may be disposed along the brim portion of the mounting plate 15.

The protrusion 15a may be formed with a light clip member. It may be inserted into a sub-bracket 19 seated on the door glass mounting portion, for example at glass run channels 5 and 6, and accordingly it may mount the mounting plate 15 on the door glass run mounting portion.

The inlet portion 15c may be further fixed to the glass run channels 5 and 6 using additional adhesive such as the double-sided tape 16, and the recess portion 15d is configured so that the flange portion 17a of the molding portion 17 can be bent and inserted therein, and thus the molding portion 17 may be robustly attached to the mounting plate 15.

The assembling guide pin 15b may be used such that the molding portion 17 is more easily attached on the door glass mounting portion.

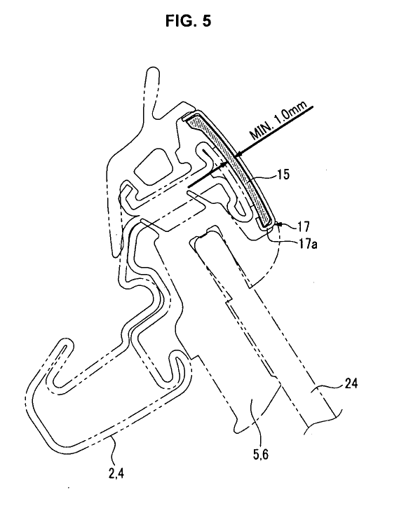

The molding portion 17 may be made of the same material as the molding portion of the rectangular member 11, as shown in FIG. 5. In addition, the molding portion 17 may have the same width at one end portion as that of the rectangular member 11, and may have a thickness that is the same as that of the rectangular member (e.g. approximately 1 mm), and thus it may provide the same external aesthetics as the rectangular member 11.

In exemplary embodiments, the mounting plate 15 is light in weight because it includes the protrusion 15a and the inlet portion 15c in a predetermined pattern, and because it is injection-molded with plastic material, and accordingly it may be easily attached on the glass run channels 5 and 6.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A door frame of a vehicle, comprising:
a door glass mounting portion; and
a door molding portion attached to the door glass mounting portion, and comprising a substantially rectangular member with a first and a second end, and a curved member with a first and a second end, the first end of the curved member being connected to the first end of the rectangular member, wherein the curved member becomes gradually wider from the first end toward the second end.

2. The door frame of a vehicle of claim 1, wherein the rectangular member is attached to the door glass mounting portion using an adhesive tape.

3. The door frame of a vehicle of claim 1, wherein the rectangular member further comprises a flange portion along a periphery thereof, and the flange portion is inserted into the door glass mounting portion.

4. The door frame of a vehicle of claim 1, wherein the rectangular member is made by a roll forming method.

5. The door frame of a vehicle of claim 1, wherein the rectangular member has a thickness of about 1 mm.

6. The door frame of a vehicle of claim 1, wherein the curved member comprises a mounting plate, a molding portion molded on the mounting plate, a protrusion protruding downward at a center of the mounting plate, and a bracket attached to the protrusion.

7. The door frame of a vehicle of claim 6, wherein the molding portion of the curved member has a thickness substantially equal to a thickness of the rectangular member.

8. The door frame of a vehicle of claim 6, wherein the molding portion has a thickness of about 1 mm.

9. The door frame of a vehicle of claim 6, wherein the molding portion comprises a flange portion at a periphery thereof such that it is fixed to the mounting plate.

10. The door frame of a vehicle of claim 9, wherein the mounting plate comprises a recess portion at a periphery thereof to which the flange portion of the molding portion is attached.

11. The door frame of a vehicle of claim 6, wherein the mounting plate comprises a clip attached to a bracket disposed at the glass run mounting portion.

12. The door frame of a vehicle of claim 6, wherein the mounting plate comprises a inlet portion, and the inlet portion is attached to the glass run mounting portion by an adhesive tape.

13. The door frame of a vehicle of claim 12, wherein the inlet portion defines a space at a lower portion of the mounting plate.

14. The door frame of a vehicle of claim 6, wherein the mounting plate has an assembling guide pin for attaching the molding portion to the glass run mounting portion.

15. The door frame of a vehicle of claim 6, wherein the molding portion is made by a pressing process.

16. The door frame of a vehicle of claim 6, wherein the mounting plate is made by a pressing process.

17. A door molding portion configured to be attached to a door glass mounting portion of a vehicle door, comprising
a substantially rectangular member with a first and a second end, and a curved member with a first and a second end, the first end of the curved member being connected to the first end of the rectangular member, wherein the curved member becomes gradually wider from the first end toward the second end.

18. The door molding portion of claim 17, wherein the curved member comprises a mounting plate, a molding portion molded on the mounting plate, a protrusion protruding downward at a center of the mounting plate, and a bracket attached to the protrusion.
